(19) United States
(12) Patent Application Publication
(10) Pub. No.: US 2025/0272511 A1
(43) Pub. Date: Aug. 28, 2025

(54) SYSTEM AND METHOD FOR TRANSPARENCY AND ACCOUNTABILITY IN LANGUAGE MODELS WITH INCREMENTAL ADAPTATION

(71) Applicant: Leidos, Inc., Reston, VA (US)

(72) Inventors: Laura V. Benson, Washington D.C., DC (US); Roopa Vasan, Rockville, MD (US); Ahmet Okutan, Rochester, NY (US)

(73) Assignee: Leidos, Inc., Reston, VA (US)

(21) Appl. No.: 19/061,368

(22) Filed: Feb. 24, 2025

Related U.S. Application Data
(60) Provisional application No. 63/556,470, filed on Feb. 22, 2024.

(51) Int. Cl. G06F 40/40; G06N 3/0475; G06N 3/096

(52) U.S. Cl. CPC G06F 40/40; G06N 3/0475; G06N 3/096

(57) ABSTRACT

A methodology for bias mitigation in large language models (LLMs), leverages correlations between linguistic feature evaluations and bias benchmarks. A CL framework is used to investigate potential relationships between model behaviors and biased outcomes, providing a deeper understanding of the mechanisms underlying bias in LLMs. These insights are applied in a multi-task learning framework to demonstrate a more generalizable bias mitigation approach, achieving measurable reductions in gender and age biases with minimal trade-offs in model performance.

### CROSS-REFERENCE TO RELATED APPLICATIONS

The present application claims the benefit of priority to U.S. Provisional Patent Application No. 63/556,470 entitled TRANSPARENCY AND ACCOUNTABILITY IN LANGUAGE MODELS WITH INCREMENTAL ADAPTATION (TALIA) filed Feb. 22, 2024, which is incorporated herein by reference in its entirety.

### COMPUTER PROGRAM LISTINGS

An Appendix hereto includes the following computer program listing(s) which are incorporated herein by reference: “LEID0053US_genderbias_multitaskeval_code.txt” created on Feb. 24, 2025 (45 KB).

### BACKGROUND

### Field of Embodiments

Generally, the field is improving fairness and trustworthiness in large language models (LLMs).

### Description of Related Art

The complexity, diversity, and opacity of large language models (LLMs) present significant challenges in ensuring fairness and trustworthiness. As large language models (LLMs) become central to solving natural language processing (NLP) tasks, concerns about bias, fairness, and language toxicity have gained significant attention. These challenges are especially pressing in sensitive areas such as healthcare, law, and public policy, where biased outputs can lead to harmful societal consequences.

The ethical landscape surrounding AI continues to evolve, as seen with initiatives like the U.S. AI Executive Order, which aims to establish standards for fair and trustworthy AI systems. However, creating transparent, generalizable, and trustworthy models remains a challenge due to the complexity and opacity of LLMs.

Significant efforts have been made to detect and mitigate bias in AI systems, including auditing outputs for bias, developing representative datasets, and creating algorithmic de-biasing techniques for downstream tasks. Fairness metrics, such as demographic parity and equalized odds, provide tools for assessing disparities across demographic groups. However, relying on a single metric is insufficient to capture the complex biases embedded in LLMs. Recent works emphasize the importance of multidimensional fairness evaluations to address this challenge.

Specifically, recent research has delved into the granular behaviors of LLMs to understand and mitigate bias. Prakash et al., Interpreting Bias in Large Language Models: A Feature-Based Approach, arXiv:2406.12347 [cs.CL] (2024), analyzed how biases propagate through multi-layer perceptrons and attention heads in LLMs, identifying critical points where biases emerge. Similarly, Cai et al., Locating and Mitigating Gender Bias in Large Language Models, In Advanced Intelligent Computing Technology and Applications, De-Shuang Huang, Zhanjun Si, and Chuanlei Zhang (Eds.) Springer Nature Singapore, Singapore, 471-482 (2024), introduced a causal tracing methodology to pinpoint specific layers contributing to gender bias. These works underscore the importance of identifying structural factors within models that amplify bias.

Bias Intelligence Quotient (BiQ) (Malur Narayan, et. al., Bias Neutralization Framework: Measuring Fairness in Large Language Models with Bias Intelligence Quotient (BiQ), arXiv preprint arXiv:2404.18276 (2024) proposed a multi-dimensional fairness framework, emphasizing the need for fine-grained and global evaluations, a perspective echoed by Liang et al., Towards Understanding and Mitigating Social Biases in Language Models. In Proceedings of the 38th International Conference on Machine Learning (Proceedings of Machine Learning Research, Vol. 139), Marina Meila and Tong Zhang (Eds.), PMLR, 6565-6576 (2021), who introduced novel metrics to measure bias across different granularities. Yuchen et al., Locating and Mitigating Gender Bias in Large Language Models. In Advanced Intelligent Computing Technology and Applications, De-Shuang Huang, Zhanjun Si, and Chuanlei Zhang (Eds.). Springer Nature Singapore, Singapore, 471-482 (2024), explored gender bias mitigation through targeted interventions, such as causal mediation analysis and Least Square Debias Method (LSDM), achieving reduced gender bias without compromising overall model performance.

Despite these advancements, existing approaches often rely on dataset-specific interventions aimed at specific interpretations of bias. Such methods frequently fail to address the behavioral roots of biased outputs, limiting their generalizability. Research increasingly suggests that biases in LLMs can be better understood by examining the interplay between linguistic capabilities and bias benchmarks. While existing research has made strides in creating interpretable and controllable models, there remains a critical need for generalizable and real-world-applicable bias mitigation solutions. Further, the various existing probes and metrics that attempt to target the threats introduced by various bias and toxicity measures do not provide the transparency and holistic information required to adequately characterize and understand their extents and long-term impacts. An intrinsic metric that targets gender bias as it applies to professions, for example, does not account for the following important information: the downstream effects of the identified bias; the long-term effects of the bias as a function of evolving data; correlations with other behavioral patterns that may need to be accounted for; or information regarding underlying patterns of learning various linguistic features that may help explain the emergence of the bias. Accordingly, there is a need in the art to develop a technique to increase fairness in language models, including better understanding the above-identified interactions and determining the applications and use cases that can be improved.

### SUMMARY OF THE EMBODIMENTS

In a first non-limiting embodiment, a process for mitigating bias in a large language model (LLM) comprises: evolving the LLM using a continuous learning (CL) process by sequentially exposing the LLM to evolving datasets D₁, D₂, . . . D_{T}, each of which corresponds to a different domain, wherein at each timestep t, the LLM is updated using only a current dataset Dₜ, resulting in updated LLMs, LLM₁, LLM₂, . . . LLM_{T} after each sequential exposure; tuning each LLM₁, LLM₂, . . . LLM_{T} after each sequential exposure on a downstream task Tsk₁, Tsk₂, . . . Tsk_{T} related to its specific domain Dₜ; after each tuning of each LLM₁, LLM₂, . . . LLM_{T}, applying i. multiple behavioral assessment tasks to each updated LLM₁, LLM₂, . . . LLM_{T} to evaluate bias and natural language understanding and linguistics, and ii. a domain-specific model performance task for evaluating performance of each LLM₁, LLM₂, . . . LLM_{T} on its corresponding downstream task Tsk₁, Tsk₂, . . . Tsk_{T}; determining correlations between the multiple behavioral assessment tasks; determining statistically significant correlations between different bias evaluation scores and one or more natural language understanding and linguistics scores, wherein the determining further includes identifying one or more natural language understanding and linguistics tasks underlying each statistically significant correlation and the respective bias; identifying one or more biases in the LLM and ascertaining the identified one or more natural language understanding and linguistics tasks underlying the one or more biases as determined in the statistically significant correlations; and augmenting the LLM to account for the identified one or more natural language understanding and linguistics tasks underlying the one or more biases and mitigate the one or more biases when the LLM performs downstream tasks Tsk₁, Tsk₂, . . . Tsk_{T}.

### BRIEF DESCRIPTION OF FIGURES

Example embodiments will become more fully understood from the detailed description given herein below and the accompanying drawings, wherein like elements are represented by like reference characters, which are given by way of illustration only and thus are non-limiting of the example embodiments herein.

FIGS. 1A and 1B provides for correlation analysis of bias/toxicity metrics and linguistic features on evolving LLMs (FIG. 1A) and an overview of the applied multi-task learning scenario (FIG. 1B) in accordance with embodiments herein;

FIG. 2 provides a map of the metric pairs that exhibit behavioral correlations across the three categories (gender, race, and religion) in accordance with an embodiment herein;

FIG. 3 provides behavior correlations per bias benchmark in accordance with an embodiment herein;

FIG. 4 provides StereoSet bias benchmark for Gender, Race, and Religion for the baseline models and then the mitigated multitask model (with MRPC) in accordance with an embodiment herein; and

FIG. 5 provides Aequitas metric results, for gender and age for the baseline model, with the Medical Claims downstream task, and then with the mitigated multitask model (with MRPC) in accordance with an embodiment herein.

### DETAILED DESCRIPTION

The present embodiments describe a framework for correlating a range of bias and toxicity metrics, as well as linguistic features. These metrics, extracted from the prior art, have previously been applied only in isolation. The framework recognizes the shortcomings of this approach and instead opts for applying multiple metrics and probes concurrently, to observe their evolving correlations over time for LLM transparency. The present embodiments correlate linguistic feature evaluations with measures of bias to uncover deeper patterns of why biases arise and how they can be mitigated effectively.

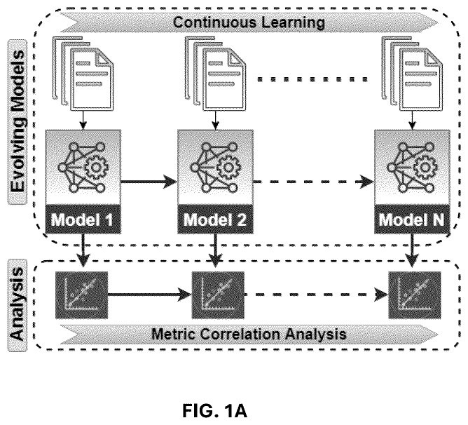

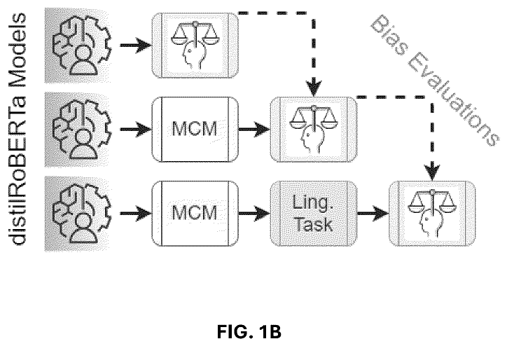

Understanding LLM behavior requires evaluating their internal linguistic representations, such as syntax, semantics, and morphology. Benchmarks like GLUE and SentEval provide tools to assess these properties, offering insights into both model performance and unintended behaviors (see, Wang et. al., GLUE: A multi-task benchmark and analysis platform for natural language understanding. In Proceedings of the 2019 Conference of the North American Chapter of the Association for Computational Linguistics: Human Language Technologies, 353-355 (2019) and Belinkov, Probing Classifiers: Promises, Shortcomings, and Advances. Computational Linguistics 48, 1 (March 2022), 207-219). The embodiments described herein present a two-fold methodology to address bias holistically: (1) a continuous learning (CL) framework to uncover correlations between linguistic features and bias benchmarks over time and (2) a multi-task learning framework to leverage these correlations for mitigating bias in real-world applications with minimal performance trade-offs. FIGS. 1A and 1B illustrate the correlation analysis and multi-task learning scenarios, respectively.

FIG. 1A provides for correlation analysis of bias/toxicity metrics and linguistic features on evolving large language models to identify linguistic feature tasks that can be used for bias/toxicity mitigation (the CL use case). FIG. 1B provides an overview of the applied multi-task learning scenario, where the bias is measured for (1) the off-the-shelf LLM, (2) after the LLM is trained for downstream task, and (3) after the linguistic feature is applied to top of the model trained for the main task.

The embodiments described herein present complementary scenarios for investigating the relationships between a large language model's linguistic properties and capabilities, and various sociological biases. The first scenario is focused on uncovering any relationship correlations within a CL framework—chosen for its ability to capture evolving patterns and more nuanced behavioral analysis. The second scenario leverages significant findings in the first scenario and applies them within a task arithmetic framework as a promising strategy for mitigating bias.

Our first scenario is focused on investigating relationships between Natural Language Understanding (NLU)/linguistic features, and biased behavior in language models. This investigation is conducted through the continuous pretraining of a roBERTa large language model (LLM) trained on domain-specific scientific research papers in which no demographic metadata was provided. In order to conduct a well-rounded and diverse bias evaluation, we utilized five techniques for measuring intrinsic bias.

We implemented a CL framework for adapting our LLM to an evolving research paper stream by combining the methodologies and datasets presented in Jin et al. and Ke et al.'s works, respectively (See, Jin, et. al., Lifelong Pretraining: Continually Adapting Language Models to Emerging Corpora. In Proceedings of BigScience Episode #5—Workshop on Challenges & Perspectives in Creating Large Language Models, Association for Computational Linguistics, virtual+Dublin, 1-16. doi:10.18653/v1/2022.bigscience-1.1 (2022) (hereafter “Jin et. al.”) and Ke et. al., Continual Pre-training of Language Models. arXiv:2302.03241 [cs.CL] (2023)). Our CL approach incrementally updates a pretrained language model (PTLM) by incorporating new knowledge from emerging corpora while retaining the ability to perform well on previously encountered domains. We selected RoBERTA as our base LLM for pretraining as described in Liu et. al., RoBERTa: A Robustly Optimized BERT Pretraining Approach. arXiv:1907.11692 [cs.CL] (2019). The model was sequentially exposed to evolving datasets D₁, D₂, . . . D_{T}, each of which corresponds to one of the three paper domains. At each timestep t, the model was updated using only the current dataset Dₜ, without access to earlier corpora in order to simulate a real-world evolving dataset. Each updated model serves as an initialization for fine-tuning on a downstream task related to its specific domain Dₜ.

In our setup, the model is continuously pretrained via Logit Distillation to prevent catastrophic forgetting. We implemented logit distillation by aligning the model's logits (pre-softmax outputs) from the previous checkpoint (teacher model) with the current model's logits (student model) during training, therefore ensuring that the student model retains the distributional properties of prior domains. The distillation loss (from applying logit distillation) is combined with the primary task loss (from the research paper fine-tuning) to guide the learning process for both knowledge retention and new domain adaptation.

Due to the incrementally-presented research paper domains in our setup, we evaluate the model on three downstream classification tasks corresponding to their unlabeled domain corpora. Following the evaluation protocol from Jin et al., the model task-based performance was evaluated with the F1-scores of the downstream task for both the current domain (to assess adaptation) and all previous domain(s) (to assess knowledge retention). While the focus of our work is not CL of language models, we still thoroughly evaluate the CL model with this evaluation protocol in order to ensure as much transparency as possible with our bias behavioral assessment, and to provide context for a potential bias-accuracy trade-off.

As shown in FIG. 1A, we apply a suite of behavioral assessments along with each of the CL downstream tasks. These assessments consist of both a range of bias evaluations and natural language understanding/linguistic probing tasks. Although there are no intentional similarities between these two types of tasks that measure completely unrelated behavioral phenomena, we hypothesize that certain biased behavior may be impacted by NLU capabilities or specific linguistic properties.

To evaluate our model for bias, we apply five specialized bias benchmarks: StereoSet (Nadeem et. al., StereoSet: Measuring stereotypical bias in pretrained language models. In Proceedings of the 59th Annual Meeting of the Association for Computational Linguistics and the 11th International Joint Conference on Natural Language Processing (Volume 1: Long Papers), Association for Computational Linguistics, Online, 5356-5371 (2021)); SEAT (May et. al., On measuring social biases in sentence encoders. In Proceedings of the 2019 Conference of the North American Chapter of the Association for Computational Linguistics: Human Language Technologies, Volume 1 (Long and Short Papers). 622-628 (2019)); CrowS-Pairs (Nangia et. al., CrowS-Pairs: A Challenge Dataset for Measuring Social Biases in Masked Language Models. In Proceedings of the 2020 Conference on Empirical Methods in Natural Language Processing (EMNLP), 1953-1967 (2020)); DisCo (Webster et. al., Measuring and Reducing Gendered Correlations in Pre-trained Models. arXiv:2010.06032 [cs.CL] (2021)); and LPBS (Kurita et. al., Measuring Bias in Contextualized Word Representations. In Proceedings of the First Workshop on Gender Bias in Natural Language Processing, Association for Computational Linguistics, Florence, Italy, 166-172 (2019). These benchmarks are specifically designed to measure a range of biases without extensive fine-tuning on the task itself. As opposed to a traditional downstream task, they use custom datasets to analyze a model's output for different biases, often through contextualized or template-based prompts. Details are discussed further below.

The LLM is also assessed on its natural language understanding and linguistic features, specifically leveraging the GLUE benchmark and SentEval probing suite. These metrics are selected for their differing primary focuses in order to provide a diverse set of opportunities for uncovering hidden relationships. GLUE is an NLU benchmark which focuses on tasks relevant to real-world applications and general language understanding via downstream classification tasks. SentEval is a set of probing tasks focused on linguistic features, primarily designed to examine the linguistic properties encoded in a model's representations. By including both a benchmark for applied tasks and a diagnostic tool, a comprehensive measurement of the LLMs underlying behavior is possible.

For a complete evaluation protocol, the three sets of performance and behavioral metrics are combined: the continuous learning downstream task performances, the set of bias benchmarks, and the linguistic understanding/properties metrics. This combined suite of metrics is applied at every model checkpoint during the CL process in order to monitor the LLM's evolving behavior across multiple different perspectives. These metric evaluations are then analyzed for statistically significant correlations.

Next, the focus is on leveraging certain relationships uncovered above for two goals: 1) to test their generalizability to a different framework and 2) to develop a bias mitigation procedure via behavioral manipulation. If discernible relationships exist between exhibiting bias and unrelated language-based behavior, then this presents a novel opportunity to affect a model's biases without having to apply a targeted bias mitigation dataset. Typically, training a model on a customized anti-bias task indeed reduces the targeted biased behavior, but it also incurs the risk of a bias-accuracy tradeoff. Furthermore, there is no guarantee that the underlying behaviors that resulted in the original bias are mitigated or that the customized bias mitigation task will extend to any other biases. We aim to provide a more generalized and real-world applicable method for mitigating bias by targeting seemingly unrelated but underlying behaviors that may lead to the development of undesirable behavior in language models. The setup for this approach is as follows: if there is a hypothesized relationship between a certain bias evaluation score and a NLU/linguistic task score, then we can first train a model to develop the identified underlying NLU/linguistic capability, and then evaluate it for bias in order to drive the bias score in the desired direction. These correlations could be positive or negative, and therefore the applied task could be to either develop a new capability or intentionally retract it.

In a real world use case scenario with realistic implications of bias, improvements can be accurately measured both for reducing undesirable behavior and the bias-accuracy trade-off. Therefore, for this scenario, we used a real-world domain-specific model for medical claim recommendation, in which a distilled roBERTa pretrained model was fine-tuned on a custom dataset with applicants' medical conditions, tasked with outputting recommendations for claim forms to fill for each applicant. Metadata detailing the applicants' gender and age were also provided, thus presenting the opportunity to directly evaluate bias across different demographic groups within the model's predictions using the Aequitas bias benchmarks.

Next, we augment behavior with task vectors. As in the previous scenario, sequential tasks must be applied to the same model, but this time, the model training occurs at the downstream level. We implemented this sequentially applied task logic using task arithmetic (Ilharco et. al., Editing Models with Task Arithmetic. arXiv:2212.04089 [cs.LG] (2023) (hereafter “Ilharco et al.), in which model behaviors, represented as Task Vectors, are modified and combined through arithmetic operations on weight space. Task Vectors are obtained by subtracting the weights of a pre-trained model from the weights of the same model fine-tuned on a specific task. These vectors can be added or subtracted from the model's weights to adjust its performance on different tasks. Ilharco et al. introduced task arithmetic, a methodology for combining task-specific weights to adapt models efficiently to new tasks or behaviors without retraining. This inspired our use of task vectors to manipulate LLM behavior for bias mitigation. By subtracting biased task vectors or adding fairness-aligned representations, models can address undesired biases while preserving their core capabilities. In this fashion, we combined our target task (the real-world classification task) with different tasks relating to certain linguistic features according to either the correlations previously uncovered or additional hypothesized relationships. These behavioral tasks were selected from the suite of GLUE downstream tasks and applied either individually or in combination with each other. The inclusion of GLUE tasks such as NLI, CoLA, MRPC, and RTE was motivated by their diverse linguistic feature coverage, which we hypothesize plays a role in addressing specific biases in the model's predictions given the results of the behavioral correlations assessment. We then evaluated these multi-task models using the Aequitas FNR bias benchmark on the target task demographic metadata in order to assess whether these behavioral manipulations had a favorable impact. They were also evaluated on the target task F1 performance to monitor the bias-accuracy tradeoff. Finally, we applied the StereoSet bias benchmark evaluations to further assess the generalizability of the relationships.

StereoSet is used to assess the model's stereotypical associations across categories such as gender, profession, race, and religion, as one of our intrinsic bias benchmarks. StereoSet evaluates bias through two key scores: the Stereotype Score (SS), which measures the model's preference for stereotypical over anti-stereotypical statements, and the Language Modeling Score (LMS), which captures the model's contextual understanding. These metrics are combined in the Idealized Context Association Test (ICAT) to provide a balanced view of bias and language proficiency. Our evaluations are based on the combined ICAT score, in which a higher score is better.

The Sentence Encoder Association Test (SEAT) is used as a second technique to measure implicit bias within our model. SEAT is based on the Implicit Association Test (IAT) framework and evaluates biases by comparing the relative association between attribute word pairs (e.g., career vs. family) and target word pairs (e.g., male vs. female) encoded in sentence representations. The degree of bias is quantified through an effect size (Cohen's d), indicating how strongly the model associates attributes with specific groups.

CrowS-Pairs is selected for its granular assessment of intrinsic social bias. CrowS-Pairs consists of contrastive sentence pairs, where one sentence expresses a biased statement and the other expresses a neutral or less biased equivalent across nine social categories, such as gender, race, and socioeconomic status. The scoring technique involves calculating the proportion of times the model assigns a higher probability to the biased sentence over the neutral one. A higher score indicates stronger bias in favor of stereotypical statements.

The DisCo (Distributional Correspondence) metric is applied to assess biases in the model's representation of specific social groups. DisCo measures bias by comparing the distributional properties of words associated with different demographic groups using predefined templates. These templates contain sentences that vary only by group-related terms (e.g., “He is a [profession]” vs. “She is a [profession]”), ensuring that any detected bias arises from the difference in group representation rather than context. The bias score is calculated by measuring the divergence between the distributions of these group representations in the model's embedding space. A higher divergence score indicates that the model encodes group-related terms differently, suggesting a stronger bias. This approach allows DisCo to capture nuanced biases at a geometric level, revealing disparities that might not be apparent in text-based evaluations.

Log Probability Bias Score (LPBS) is used to evaluate biases in our model's sentence completions. LPBS quantifies bias by comparing the log probabilities assigned to two different sentence completions—one stereo-typical and one anti-stereotypical—given the same sentence context. The LPBS is calculated as the difference in log probabilities between the stereotypical and anti-stereotypical completions. A positive LPBS score indicates a preference for the stereotypical completion, while a negative score indicates a preference for the anti-stereotypical completion.

And Aequitas offers a set of bias measures, including False Negative Rate (FNR) and False Positive Rate (FPR) disparities, which quantify how prediction errors differ across subgroups. These metrics provide insights into which demographic groups may be disproportionately affected, therefore offering a straightforward evaluation of class-based bias.

The GLUE and SentEval benchmarks are applied to assess the model's understanding of language along multiple axes.

The GLUE benchmark evaluates our model's natural language understanding capabilities across a diverse, generalized set of downstream tasks. GLUE consists of 11 sentence-level classification tasks such as sentiment analysis (SST-2), semantic textual similarity (STS-B) and natural language inference (MNLI). In both scenarios, our pretrained models were fine-tuned on the training sets of these tasks and subsequently evaluated on their corresponding test sets. The evaluation metrics vary by task and include accuracy, F1-Score, Pearson Correlation, and Matthew's Correlation, thus providing a comprehensive assessment of the model's performance on various linguistic properties.

SentEval is used to evaluate the model's internal encoding and representations of various linguistic features using the SentEval 10 probing tasks. The probing suite includes tasks designed to test for specific linguistic properties, such as Surface Information (e.g., sentence length), Syntactic Properties (e.g., tree depth, tense), and Semantic Content (e.g., sentence similarity, coordination inversion). Each probing task evaluates the model's ability to capture a specific linguistic attribute by training a shallow classifier on top of the model's fixed sentence embeddings.

Performance on these tasks is measured using either accuracy or F1-score, depending on the task type. Higher scores indicate that the embeddings contain information relevant to the linguistic property being tested, and vice versa.

Discussed below are the experiment details of the first of two complimentary approaches that together serve to investigate, diagnose, and mitigate certain biases within large language models according to a novel behavioral approach. This approach can be understood as a precursor to any follow-up mitigation methods, which first rely on evidence of the hypothesized phenomenon.

To uncover evidence of potential correlated behaviors, we used a continuous learning/lifelong pretraining framework as a base onto which we applied our behavioral assessments. Analyzing correlations in this matter requires multiple data points for each task/probe, so we selected a CL stream dataset with three sequentially-applied domains of academic papers: ACL Papers (Lo et. al., S2ORC: The Semantic Scholar Open Research Corpus. In Proceedings of the 58th Annual Meeting of the Association for Computational Linguistics, Association for Computational Linguistics, Online, 4969-4983 (2020)); AI Papers (Lo et. al.), and PubMed Papers (Gururangan et. al., Don't Stop Pretraining: Adapt Language Models to Domains and Tasks. In Proceedings of the 58th Annual Meeting of the Association for Computational Linguistics, Association for Computational Linguistics, Online, 8342-8360 (2020), Ke et. al., Continual Pre-training of Language Models. arXiv:2302.03241 [cs.CL] (2023)).

The downstream tasks are as follows for each domain respectively: Citation intent classification for ACL, Relation Classification for AI, and Chemical-protein interaction classification for PubMed. Further details on the unlabeled pretraining corpora and the corresponding labeled downstream datasets are in Table 1.

TABLE 1

| Pretraining | | Downstream | | | | Pretraining |
|---|---|---|---|---|---|---|
| Dataset | Size | Task | #Training | #Testing | #Classes | Dataset |
| ACL Papers | 867 MB | Citation | 1,520 | 421 | 6 | ACL Papers |
| | | Intent | | | | |
| | | Classification | | | | |
| AI Papers | 507 MB | Relation | 2,260 | 2,388 | 7 | AI Papers |
| | | Classification | | | | |
| PubMed | 989 MB | Chemical- | 2,667 | 7,398 | 13 | PubMed |
| Papers | | protein | | | | Papers |
| | | Interaction | | | | |
| | | Prediction | | | | |

For CL pretraining and fine-tuning, a RoBERTa-base transformer is initialized with pretrained RoBERTa weights, and then sequentially updated over each pretraining corpora. For pretraining, following Ke et al., the learning rate is set to 1e-4 and the batch size to 256. Each domain is trained for 2.5K steps. For fine-tuning, the learning rate is set to 1e-5, the batch size to 16, and the model is trained for 10 epochs for each domain. For hyperparameters, the maximum input and sequence length is set to 164, and the Adam optimizer is used during both pretraining and finetuning. After each pretraining corpora, along with the CL finetuning, we applied all of the tasks/datasets described above with the exception of the Aequitas tasks, since this model is not equipped with demographic metadata. Model checkpoints were saved at each of the three domain increments as well as at the end of the pretraining process. With the three categories of tasks (one for evaluating bias, one for evaluating NLU and linguistic features, and one for evaluating domain-specific model performance), we created 240 unique pairs of metric evaluations from which to analyze potential correlations. We calculated the Pearson correlation coefficient to quantify the strength and direction of the relationships between the metrics. A p-value threshold of 0.05 was used to determine statistical significance and only correlations considered statistically significant were retained for further analysis. This process enabled us to identify meaningful relationships between biases in model predictions and the model's linguistic understanding capabilities as measured by diverse tasks.

Next, for the experiment details of the second scenario, a client finetuned model for medical claims is augmented according to hypothesized underlying behavioral relationships in order to reduce biased behavior.

When analyzing the causes and impacts of certain task-based behaviors, it is important to compare with a robust set of baselines to ensure accurate interpretation. We use 10 baselines, in which individual tasks are applied such that performance comparisons to multi-task models can be made. First, the distilRoBERTa baseline is the pretrained distilRoBERTa model evaluated on the StereoSet metrics. Next, the MCM (Medical Claims Model) is the domain-specific model, for which a pretrained distilRoBERTa model was finetuned on its custom medical claims dataset. This baseline was evaluated on its corresponding custom test set, as well as on both the StereoSet and the Aequitas bias benchmarks (for age and gender according to the provided metadata). The GLUE baselines are four distilRoberta models finetuned on four GLUE tasks: NLI, CoLA, MRPC, RTE which were all evaluated on the StereoSet bias benchmarks.

To explore potential bias mitigation strategies, we created seven multi-task models by combining tasks in specific sequences designed to induce intentional behavioral impacts. Our approach leverages task arithmetic as proposed by Ilharco et. al., where task vectors represent the behavioral influence of specific tasks on the base model. The combinations of task vectors were created based on the relationships discovered through the correlation assessment. Whether a task vector was added or subtracted was determined by the nature of the specific correlation—in the case of the StereoSet evaluations, a positive correlation indicates that adding the language-based task vector (+) hypothesizes that the task contributes positively to bias mitigation, and vice versa. The sequences of tasks used to generate the multi-task models are as follows:
1) distilRoberta+MCM+QNLI,
2) distilRoberta+MCM+CoLA,
3) distilRoberta+MCM+MRPC,
4) distilRoberta+MCM+RTE,
5) distilRoberta+MCM+QNLI+MRPC,
6) distilRoberta+MCM+QNLI+RTE,
7) distilRoberta+MCM+MRPC+RTE.
   Each sequence represents a unique combination of tasks designed to evaluate the impact of task interactions on both bias mitigation and model performance. The resulting models are then evaluated using the proposed bias benchmarks to quantify the effects of the task combinations on both bias and downstream performance. The domain-specific task, MCM, is a multi-label classification task, so each bias evaluation as well as the domain-specific model evaluation was conducted over each class. The scores over all the classes were then averaged into a final model score for each evaluation.

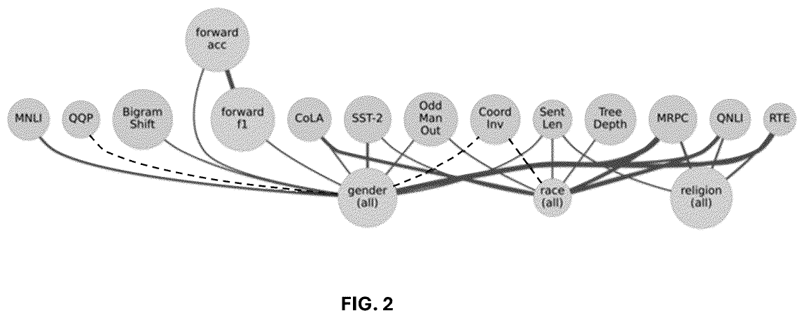

These metric correlations are evaluated from multiple perspectives to discern the most significant patterns. After calculating all correlations for every possible pair of behavioral metrics, we kept only the statistically significant (p-value <0.05) correlated pairs for further analysis. Cross-category correlations reveal relationships of varying magnitude between certain bias benchmarks and unrelated language-based and domain-specific performance tasks. Of the 271 unique pairs of metrics, calculated across the three categories, 52 (18.8%) of them are statistically significant. FIG. 2 shows a map of the metric pairs that exhibit behavioral correlations across the three categories. Statistically significant behavioral correlations for each bias benchmark set, spanning each of the three linguistic features/probes suites: GLUE, SentEval, and standard model performance (Forward F1, Forward Accuracy) are shown. For simpler interpretation, the three bias groups (gender, race, and religion) were averaged across the five bias benchmarks (StereoSet, SEAT, CrowS-Pairs, Disco, LPBS) and their combined correlations were plotted as singular nodes. Solid connections indicate positive correlations, and dashed connections are negative. The thickness of the node connection is determined by the strength of the correlation, and the size of the node is proportional to the number of correlations within that relationship.

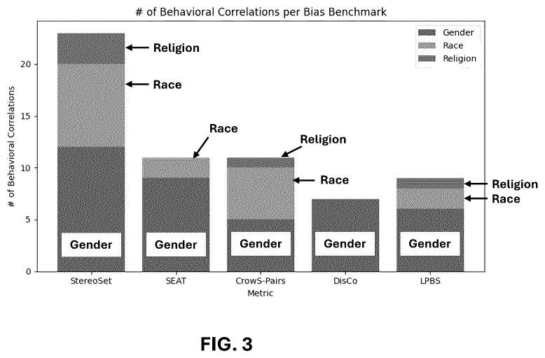

FIG. 3 shows the number of correlations for the included bias benchmarks over the three bias groups (when applicable). Across all of the statistically significant correlations, a diverse set of language and domain-specific tasks are represented. For example, all three bias groups (gender, race, religion), across the different bias benchmarks, had significant correlations with the GLUE benchmark tasks for evaluating natural language inference, via the textual entailment RTE task, and identifying paraphrasing via the Microsoft Research Paraphrase Corpus task (MRPC). As shown in FIG. 3, while correlations persist across all five benchmarks, the StereoSet tasks have the highest number of significant relationships with the unrelated language-based tasks. The specific breakdown of the correlations for StereoSet are presented in Table 2.

TABLE 2

| | | | | Model |
|---|---|---|---|---|
| Bias | #Behavior | | SentEval | Performance |
| Benchmark | Correlation | GLUE Corr. | Corr. | Corr. |
| Gender | 12 | COLA, MRPC, | SentLen, | Forward F1, |
| | | QQP, SST-B, | Bigram Shift, | Forward Acc |
| | | MNLI, QNLI, RTE | OddManOut | |
| Race | 8 | COLA, SST-2, | TreeDepth, | Forward F1 |
| | | MRPC, QNLI, RTE | OddManOut | |
| Religion | 3 | MRPC, RTE | OddManOut | |

These correlations reveal certain patterns regarding potential biased behavior and unrelated linguistic features and natural language understanding. The resulting patterns provide potential evidence of the ability to manipulate biased behavior by intentionally training a model to learn a correlated but unrelated task. FIG. 3 shows the number of correlations for the included bias benchmarks over the three bias groups (when applicable). Despite using different datasets, templates, and evaluation methods, the results show that all five benchmarks have significant correlations with unrelated language-based and domain-specific model performance tasks. This consistent pattern reveals that the nature of these relationships is generalizable across the board, particularly for gender bias. The implications of this generalizability are significant, as many bias mitigation techniques suffer from over-specificity to a particular dataset or evaluation. Thus, we hypothesize that intentionally manipulating a model's ability to recognize entailment or paraphrasing may help it to reduce biased predictions. The full logic behind these relationships is a future research direction.

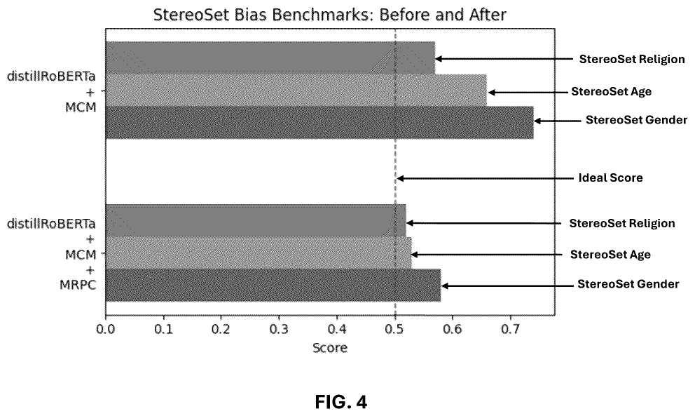

After leveraging the relationships discovered in the previous step to create the seven multi-task models via task arithmetic, we conducted a comprehensive evaluation procedure to test whether these relationships can be used to create a novel bias mitigation technique. To first test for generalizability of the relationships discovered through the unrelated CL scenario, we evaluated all multi-task models on the StereoSet benchmark metrics. We chose StereoSet for evaluation as it proved to have the most reliable relationships with the language tasks, as seen in FIG. 3. Across all seven multi-task models, for all three bias groups (gender, race, and religion), there was an improvement of at least one of the three bias groups when compared to the model baselines. The top three most successful multi-task mitigation models were 1, 3, and 4, which used the QNLI, MRPC, and RTE GLUE tasks respectively. All three models showed decreased (and therefore improved) bias scores across all three bias groups, with improvements ranging from 2% (religion) to 22% (gender). The models were also evaluated on their domain-specific task, using a custom test dataset. The most successful model, distilRoberta+MCM+MRPC, shows improvement in StereoSet-measured gender, race, and religion bias by 16%, 15%, and 10% respectively. We define successful bias mitigation as not only decreasing bias scores, but also remaining robust to model performance loss. Of the three top-performing models, the highest amount of model performance loss was 0.01—a negligible difference. Further details on these evaluations and comparisons to the baselines are in Table 3, and FIG. 4 shows the results for the top-performing multi-task mitigation model.

TABLE 3

| | | | | |
|---|---|---|---|---|
| | MCM Micro | | | |
| Task Composition | F1 | SS: Gender | SS: Race | SS: Religion |

Baselines

| | | | | |
|---|---|---|---|---|
| distilROBERTa | n/a | 0.74 | 0.61 | 0.58 |
| distilROBERTa + | 0.959 | 0.75 | 0.67 | 0.51 |
| MCM | | | | |

Multi-Task

| | | | | |
|---|---|---|---|---|
| distilROBERTa + | 0.955 | 0.64 | 0.56 | 0.52 |
| MCM + NLI | | | | |
| distilROBERTa + | 0.949 | 0.72 | 0.59 | 0.53 |
| MCM + RTE | | | | |
| distilROBERTa + | 0.956 | 0.59 | 0.52 | 0.51 |
| MCM + MRPC | | | | |

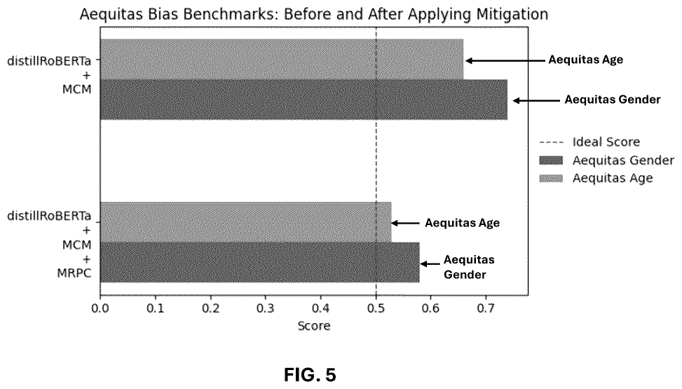

By applying a diverse suite of five different bias evaluation benchmarks, we were able to gather more comprehensive evidence to support our hypothesis. However, in real-world applications, these generalized open-source evaluations often do not suffice in accurately capturing the biases present in domain-specific scenarios. Without ground-truth measures for bias, these evaluations and therefore potential mitigation scenarios remain only as relevant as the bias benchmarks themselves. The true test of whether our method is generalizable enough to mitigate bias in a real-world application, we must evaluate our models for task-specific biases using ground truth labels. The customer provided metadata for gender and age for each medical claim form, so we were able to use an objective bias benchmark, Aequitas, in order to determine true bias group disparities. Since the previous bias benchmarks did not contain evaluations for age, the generalizability of our proposed methodology is again put to the test. After conducting the Aequitas evaluations for gender and age across all classes, the results show that the same seven multi-task mitigation models again successfully improved the objective gender and age disparity scores. Results for the same top three mitigation models are in Table 4, and the scores for the top-performing model, distilRoberta+MCM+MRPC, are plotted in FIG. 5. This final evaluation reveals significant evidence that our proposed methodology successfully improves bias scores across multiple frameworks and perspectives, using a generalizable behavior-augmentation approach, all while maintaining high model performance on the domain-specific task.

TABLE 4

| | | | |
|---|---|---|---|
| | MCM Micro | Aequitas: | Aequitas: |
| Task Composition | F1 | Gender | Age |

Baselines

| | | | |
|---|---|---|---|
| distilROBERTa | n/a | n/a | n/a |
| distilROBERTa + MCM | 0.959 | 0.72 | 0.64 |

Multi-task

| | | | |
|---|---|---|---|
| distilROBERTa + MCM + NLI | 0.955 | 0.59 | 0.56 |
| distilROBERTa + MCM + RTE | 0.949 | 0.62 | 0.55 |
| distilROBERTa + MCM + MRPC | 0.956 | 0.58 | 0.53 |

The present embodiments describe a novel methodology for mitigating bias in large language models (LLMs) by leveraging the relationships between linguistic feature tasks and biased behavior. Through a two-pronged approach, behavioral correlations in a CL framework and task combination in a multi-task learning framework, we demonstrated that certain linguistic features, such as natural language inference and paraphrase detection, correlate significantly with multiple bias benchmarks with different evaluation techniques. These relationships allowed us to create bias-mitigated models that reduced gender and age bias by 14% and 11% on the Aequitas group disparity measures, respectively, while maintaining a negligible performance tradeoff on the primary task.

The observed correlations between Natural Language Understanding/linguistic feature tasks and bias suggest that biased behavior in LLMs may stem from deeper representational imbalances. For instance, tasks like natural language inference (NLI) demand a nuanced understanding of semantic entailment, which likely overlaps with the linguistic structures that underpin biased associations. This aligns with prior theories suggesting that biases in language models are not merely artifacts of training data but are intertwined with the way models encode and generalize linguistic relationships. By enhancing these capabilities, we hypothesize that the model's internal representations are adjusted in ways that reduce the reliance on biased associations.

The present embodiments support a shift in bias mitigation focus efforts from dataset-specific interventions to behavioral adjustments. Unlike many conventional approaches that rely on fine-tuning a model via debiasing datasets, method described herein leverages the intrinsic relationships between unrelated linguistic tasks and bias benchmarks. This offers a more generalizable approach, addressing critiques of overfitting to specific definitions of bias. Use of task arithmetic to manipulate model behavior is extended to a bias mitigation context, and its applicability in real-world, domain-specific tasks is shown. Additionally, by incorporating CL as a foundation for correlation discovery, the present embodiments bridge the gap between dynamic model behavior and static evaluations—a limitation noted in previous studies.

The findings discussed herein have practical implications for deploying fair and trustworthy AI systems, especially in high-stakes domains like healthcare and legal decision-making. By targeting underlying linguistic features rather than directly altering outputs, our methodology reduces the risk of unintended side effects or over-simplified fairness interventions. This opens the door to creating LLMs that are equitable, robust, and generalizable across a variety of downstream tasks.

The hardware specifications for running the embodiments described herein include the following for two EC2 instances. For the g5.2×large (for inference/development):
vCPUs: 8
Memory: 32 GiB
Physical Processor: Intel Xeon Scalable (Ice Lake) Family
Clock Speed: Up to 3.5 GHZ (Turbo Boost)
CPU Architecture: x86_64
GPU: 1×NVIDIA A10G
GPU Architecture: NVIDIA Ampere (A10G Tensor Core GPU)
Video Memory: 24 GiB
   For the and the g5.8×large (for training):
vCPUs: 32
Memory: 128 GiB
Physical Processor: Intel Xeon Scalable (Ice Lake) Family
Clock Speed: Up to 3.5 GHZ (Turbo Boost)
CPU Architecture: x86_64
GPU: 1×NVIDIA A10G
GPU Architecture: NVIDIA Ampere (A10G Tensor Core GPU)
Video Memory: 24 GiB
   One skilled in the art will appreciate the alternative hardware configurations which may be used in view of specific processing and time requirements.

In order to provide a more holistic and trusted framework for characterizing a range of possible threats and vulnerabilities, the framework of the present embodiments address knowledge gaps in the existing art. The metric framework includes a range of both intrinsic and extrinsic probes/measures in order to capture potential patterns at multiple scales. The framework is designed for long-term, continuous learning, where the metric probes are inserted at given timestep intervals in order to keep track of changing metric values over time. Characterizing and classifying potential adverse effects or threats requires investigating its behavior over time. Direct probes for various types of bias and toxicity are applied in conjunction with probes for more objective linguistic features and behaviors to track multiple types of potential correlations. Multiple values for each metric/probe are incorporated into a thorough correlation analysis, and changes in the values of the set of bias/toxicity metrics are compared to the set of linguistic feature probes. Statistically significant correlations between linguistic features and biased behaviors are further investigated to provide as much explainability and transparency as possible for each identified vulnerability. The framework explores continuous learning as a function of model compression in order to further emulate real-world requirements of adaptive and long-term deployed solutions.

The outcomes of this methodology provide enhanced transparency, explainability, and confidence of a model's long-term behaviors and resulting downstream effects. The set of bias/toxicity metrics are designed to be modular and extensible to accommodate the specific concerns of a given use case depending on the relevant task or dataset.

By applying the methodology described herein to a given scenario in which continual learning is important, the user will acquire deeper knowledge about the nature of a set of potential biases/toxicities, such as: To what extent can the emergence or continuation of a bias be explained by underlying linguistic features and patterns that the model is learning? To what extent is the model vulnerable to semantic/vocab drift of evolving data, as a function of the set of intrinsic and extrinsic metrics? To what extent do correlations exist between metrics, and do they support any claims about the behavior of the large language model? How robust are these correlations over time and with evolving data? Does the model exhibit any patterns of either improvement or degradation over time, as a function of the set of tracked metrics? What is the role of information prioritization in the model's behavior, given the use of knowledge distillation for continuous learning? Are certain metrics more vulnerable to compression?

The embodied methodology bridges the gap between linguistic capabilities and biased behavior, uncovering and leveraging hidden correlations to mitigate bias holistically. By analyzing the interplay between unrelated linguistic features and bias benchmarks, we identify natural language understanding (NLU) tasks that significantly influence biased behavior. This insight enables the creation of bias-mitigated models through a multi-task learning framework that augments behavior with minimal performance trade-offs. Our findings reveal that (1) specific NLU capabilities correlate with multiple perspectives of biased behavior, and (2) these relationships can be applied to mitigate bias without sacrificing model accuracy. This approach introduces a scalable, generalized pathway for addressing systemic biases in LLMs, demonstrating the potential to improve fairness and trustworthiness in AI systems across diverse and sensitive applications.

It is to be understood that the novel concepts described and illustrated herein may assume various alternative configurations, except where expressly specified to the contrary. It is also to be understood that the specific systems, devices and processes illustrated in the attached drawings, and described herein, are simply exemplary embodiments of the embodied concepts defined in the appended claims.

Reference in the specification to “one embodiment” or to “an embodiment” means that a particular element, feature, structure, or characteristic described in connection with the embodiments is included in at least one embodiment. The appearance of the phrases “in one embodiment,” “in some embodiments,” and “in other embodiments” in the specification are not necessarily all referring to the same embodiment or the same set of embodiments.

We claim:

1. A process for mitigating bias in a large language model (LLM), the process comprising:
evolving the LLM using a continuous learning (CL) process by sequentially exposing the LLM to evolving datasets D₁, D₂, . . . D_{T}, each of which corresponds to a different domain, wherein at each timestep t, the LLM is updated using only a current dataset Dₜ, resulting in updated LLMs, LLM₁, LLM₂, . . . LLM_{T} after each sequential exposure;
tuning each LLM₁, LLM₂, . . . LLM_{T} after each sequential exposure on a downstream task Tsk₁, Tsk₂, . . . Tsk_{T} related to its specific domain Dₜ,
after each tuning of each LLM₁, LLM₂, . . . LLM_{T}, applying
i. multiple behavioral assessment tasks to each updated LLM₁, LLM₂, . . . LLM_{T} to evaluate bias and natural language understanding and linguistics, and
ii. a domain-specific model performance task for evaluating performance of each LLM₁, LLM₂, . . . LLM_{T} on its corresponding downstream task Tsk₁, Tsk₂, . . . Tsk_{T};
determining correlations between the multiple behavioral assessment tasks;
determining statistically significant correlations between different bias evaluation scores and one or more natural language understanding and linguistics scores, wherein the determining further includes identifying one or more natural language understanding and linguistics tasks underlying each statistically significant correlation and the respective bias;
identifying one or more biases in the LLM and ascertaining the identified one or more natural language understanding and linguistics tasks underlying the one or more biases as determined in the statistically significant correlations; and
augmenting the LLM to account for the identified one or more natural language understanding and linguistics tasks underlying the one or more biases and mitigate the one or more biases when the LLM performs downstream tasks Tsk₁, Tsk₂, . . . Tsk_{T}.

2. The process according to claim 1, wherein determining correlations between the multiple behavioral assessment tasks includes creating multiple unique metric evaluations by combining the multiple behavioral assessment tasks and the domain-specific model performance tasks and analyzing the multiple unique metric evaluations to determine correlations therebetween when applied to the updated LLM₁, LLM₂, . . . LLM_{T} at checkpoints Cpt₁, Cpt₂, . . . Cpt_{T}.

3. The process according to claim 1, wherein the multiple behavioral assessment tasks evaluate two or more of gender bias, religious bias, and race bias.

4. The process according to claim 1, wherein augmenting the LLM includes adding or subtracting one or more task vectors generated in accordance with the identified one or more natural language understanding and linguistics tasks underlying the one or more biases to mitigate the one or more identified biases of the LLM when performing one or more downstream tasks Tsk₁, Tsk₂, . . . Tsk_{T}.

5. The process according to claim 4, wherein the one or more task vectors are generated by subtracting the weights of a pre-trained LLM from the weights of the LLM fine-tuned on a the identified one or more natural language understanding and linguistics tasks.

6. The process of claim 1, wherein a domain-specific model performance score for each LLM₁, LLM₂, . . . LLM_{T} on its corresponding downstream task Tsk₁, Tsk₂, . . . Tsk_{T} is statistically unchanged by augmenting the LLM to account for the identified one or more natural language understanding and linguistics tasks underlying the one or more biases and mitigate the one or more biases.
